(19) United States
(12) Patent Application Publication
(10) Pub. No.: US 2007/0274758 A1
(43) Pub. Date: Nov. 29, 2007

(54) Merchandise Detecting And Billing Device Having A Plurality Of Receipt Dispensers

(75) Inventors: Gunter Baitz, Berlin (DE); Wolfgang Malke, Berlin (DE)

Correspondence Address: HARNESS, DICKEY & PIERCE, P.L.C., P.O. BOX 828, BLOOMFIELD HILLS, MI, 48303, US

(73) Assignee: Wincor Nixdorf International GmbH, Paderborn (DE)

(21) Appl. No.: 10/594,538

(22) PCT Filed: May 4, 2005
(86) PCT No.: PCT/DE05/00827

§ 371 Date: Sep. 27, 2006

(30) Foreign Application Priority Data
May 13, 2004 (DE) 20 2004 007 823.6

(51) Int. Cl. B41J 11/00

(52) U.S. Cl. 400/605

(57) ABSTRACT

Merchandise detecting and billing device having a plurality of receipt dispensers (12L, 12R) whose discharge channel (26) has an adjoining diverting means (28) which is able to direct printed material (22) into at least two transportation channels (30L, 30R) which each lead to a printed material dispenser (12L, 12R).

The invention relates to a merchandise detecting and billing device having a plurality of receipt dispensers, which device can be simultaneously used by a plurality of users. Said invention is based on EP 0 970 453 B1.

EP 0 970 453 B1 describes a merchandise detecting and billing device which can be operated from more than one side, with a respective sales slip printer being arranged on each side. However, employing a plurality of sales slip printers in one billing device means a high level of outlay and is therefore very cost-intensive.

The object of the invention is therefore to propose a merchandise detecting and billing device in which a plurality of receipt dispensers can be supplied with a receipt with as little outlay as possible.

This object is achieved by the features of claim 1.

The provision of at least two transportation channels means that a receipt can be directed from a single sales slip printer to the at least two receipt dispensers.

Each transportation channel preferably comprises at least one endless transportation belt, which is respectively stretched between deflection rollers, and a transportation surface, between which endless transportation belt and transportation surface a receipt can be transported. Two transportation channels are arranged next to one another, with the directions of circulation of the belts of the two transportation channels running in opposite directions to one another in the direction of the respective receipt dispensers. An adjustable diverting means which, depending on its position, threads a receipt coming from the printer into one of the two transportation channels, is arranged in the intermediate region between the transportation channels.

According to one preferred development of the invention, the diverting means is provided with a guide surface and equipped with an actuating drive by means of which the guide surface can be moved in the direction of one or the other transportation channel, so that the receipt is threaded into one or the other transportation channel, depending on the position of the diverting means.

Further features and advantages of the invention can be found in the following description which explains the invention with reference to one exemplary embodiment in conjunction with the attached drawing, in which

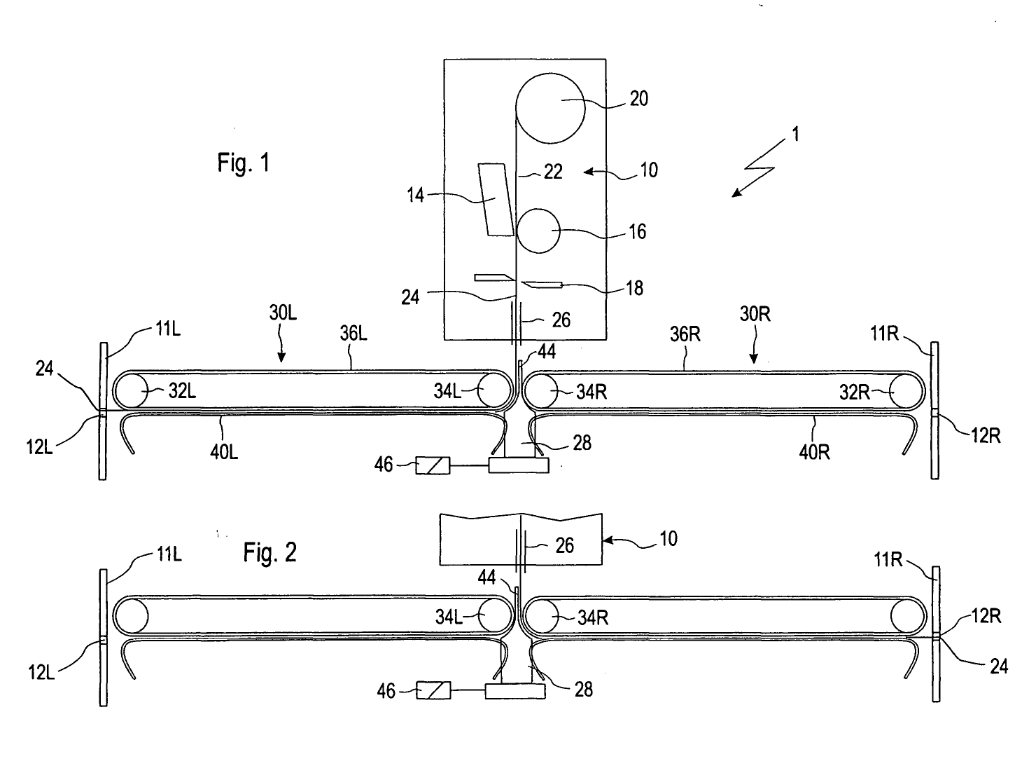

FIG. 1 shows a schematic view of a sales slip printer with two receipt dispensers and a diverting means in a first position; and

FIG. 2 shows the sales slip printer from FIG. 1, with its diverting means being in a second position.

FIG. 1 shows a schematic view of a sales slip printer 10, which is installed in a merchandise detecting and billing device 1, with a receipt dispenser 12L which is embedded in a left-hand wall 11L of the billing device 1, and a receipt dispenser 12R which is embedded in a right-hand wall 11R of the billing device 8. The sales slip printer 10 may be a thermal printing strip 14 with a contact-pressure roller 16 opposite said strip, and a cutting device 18. However, an ink-jet printer, a dot matrix printer or else a laser printer may be used within the scope of the invention. Material 22 to be printed which is taken from a supply roll 20 is cut into individual receipts 24 by the cutting device 18 after being printed. The receipts 24 leave the sales slip printer 10 through a discharge channel 26. However, it is also possible to use individual sheets for printing purposes, which sheets are then fed to the discharge channel 26.

In FIG. 1, a diverting means 28 is arranged beneath the discharge channel 26, this diverting means directing the receipt 24 either into a left-hand transportation channel or into a right-hand transportation channel 30R, depending on the position of said diverting means. The transportation channels 30L, 30R run in opposite directions to one another. The diverting means 28 is controlled as a function of whether the billing device 1 is operated from the left-hand side or from the right-hand side.

Each transportation channel 30L, 30R preferably comprises an endless belt 36L or 36R, which is stretched out between deflection rollers 32L, 34L and 32R, 34R, and a transportation surface 40L, 40R which rests against the transportation belt 36L or 36R. The transportation surfaces 40L, 40R can be formed by a further transportation belt which is stretched between deflection rollers which are not illustrated here. The diverting means 28 is provided with a guide surface 44 in the region of the deflection rollers 34L and 34R which face one another.

The diverting means 28 is equipped with a preferably electromechanically operated actuating drive 46 which can be used to move the guide surface 44 to the right-hand side (FIG. 1) or to the left-hand side of the discharge channel 26 (FIG. 2). The movement may be performed by shifting or pivoting.

A receipt 24 which emerges from the discharge channel 26 is picked up by the left-hand or right-hand circumferential section of the deflection roller 34L, 34R, depending on the diverting position, and inserted into the gap between the associated transportation channel 30L, 30R. Said receipt is advanced by the belt of the transportation channel 30L, 30R until it emerges from the left-hand or right-hand receipt dispenser 12L, 12R. At this point, it can be removed by a user or falls into a receipt dispenser tray.

1. A merchandise detecting and billing device comprising a sales slip printer and at least two receipt dispensers, with the receipt dispensers each being connected to one transportation channel, and a receipt which is printed by the sales slip printer being directed by a diverting means to a transportation channel which leads to a receipt dispenser.

2. The merchandise detecting and billing device as claimed in claim 1, wherein each transportation channel comprises at least one endless belt, which is stretched between deflection rollers, and a transportation surface which runs parallel to the endless belts, and the transportation channels are arranged next to one another, with the directions of circulation of the endless belts running in opposite directions and the diverting means being arranged in the intermediate region between the transportation channels.

3. The merchandise detecting and billing device as claimed in claim 1 with the diverting means having a guide surface.

4. The merchandise detecting and billing device as claimed in claim 1, wherein the diverting means can be moved between the transportation channels by means of an actuator drive.
